(19) United States
(12) Patent Application Publication
(10) Pub. No.: US 2026/0252773 A1
(43) Pub. Date: Aug. 27, 2026

(54) SYSTEM AND METHOD FOR RECREATING SILICON BEHAVIOR OF SYSTEM ON CHIP

(71) Applicant: SAMSUNG ELECTRONICS CO., LTD., Suwon-si (KR)

(72) Inventors: Sampathkumar M BALLARY, Bengaluru (IN); Karthik SRINIVASAN, Bengaluru (IN); Aruna Shamsunder LOHIYA, Bengaluru (IN); Ramesh Ganesh PATGAR, Bengaluru (IN); Vandana S, Bengaluru (IN); Samruddhi C R, Bengaluru (IN); Venkata Krishna VADDEVALLI, Bengaluru (IN)

(73) Assignee: SAMSUNG ELECTRONICS CO., LTD., Suwon-si (KR)

(21) Appl. No.: 19/545,764

(22) Filed: Feb. 20, 2026

(30) Foreign Application Priority Data
Feb. 21, 2025 (IN) 202541015131
Feb. 13, 2026 (IN) 202644016382

(51) Int. Cl. G06F 30/3308; G06F 115/02

(52) U.S. Cl. CPC G06F 30/3308; G06F 2115/02

(57) ABSTRACT

A system for recreating silicon behavior of a System on Chip (SoC) includes one or more traffic generators configured to generate traffic injectable into a Network on Chip (NoC) of the SoC based on silicon dump data, and a configurable memory controller configured to receive the silicon dump data associated with one or more masters of the SoC and the NoC, control one or more memory access latencies associated with the traffic based on one or more pre-configured master-corresponding latency values, and recreate the silicon behavior of the SoC by executing the traffic with the controlled one or more memory access latencies.

### CROSS-REFERENCE TO RELATED APPLICATIONS

This application claims priority under 35 U.S.C. § 119 to Indian Patent Application No. 202541015131, filed on February 21, 2025, in the Indian Patent Office, the disclosure of which is incorporated by reference herein in its entirety.

### BACKGROUND

### Field

The present disclosure relates generally to System on Chip (SoC) architecture and performance validation, and more particularly, to a system and method for recreating silicon behavior of a SoC.

### Description of Related Art

System on Chip (SoC) architectures may have increased in complexity. For example, SoC architectures may integrate multiple processing masters, memory controllers, interconnect fabrics, such as, but not limited to, Network on Chip (NoC) structures, or the like. These designs may enable high-performance computing for applications including, but not limited to, multimedia processing, camera systems, display rendering, and/or various other computational tasks. Along with increases in SoC complexity, validating and/or debugging the behavior of these integrated systems may also increase.

During the development and production lifecycle of SoC devices, various performance-related issues in the manufactured silicon may be encountered. These issues may manifest, for example, as camera overflows, display glitches, audio artifacts, or other anomalies that may affect the proper functioning of the device. When such issues are discovered in actual silicon, the root cause of such issues may need to be identified or understood, and appropriate remediation strategies may need to be developed.

Related approaches to analyzing silicon behavior may involve examining data dumps captured from the actual silicon device. These data dumps may include transaction logs from bus monitoring logs and internal state information from debug interfaces. However, analyzing these dumps in isolation may provide limited visibility into the dynamic interactions between various SoC components during operation.

Simulation and emulation platforms may offer alternative approaches for studying SoC behavior. These platforms may allow for the behavior of SoC components to be modeled and to observe interactions between the SoC components in a controlled environment. However, typical simulation approaches may employ simplified models that may not accurately reflect the behavior observed in actual silicon. The discrepancy between simulated behavior and actual silicon behavior may limit the effectiveness of these platforms for debugging and/or validation purposes.

The ability to accurately reproduce silicon behavior in a simulation and/or emulation environment may provide greater flexibility to study issues, evaluate potential fixes, and/or validate changes before implementing the potential fixes in production silicon. Such a capability may be beneficial for potentially reducing the time and/or resources associated with debugging silicon issues and/or validating design modifications.

Furthermore, as SoC architecture may continue to evolve with new configurations of processing elements, memory subsystems, and interconnect topologies, there may be a general interest in platforms that may support architectural validation for future designs. Such platforms may enable evaluation of design decisions, such as, but not limited to, changes to bus architectures, buffer depths, memory organization, or the like, prior to silicon fabrication.

Therefore, there exists for further improvements in SoC technology, as a need to overcome one or more of above-mentioned limitations may constrain further increasing the complexity of SoC architectures.

### SUMMARY

This summary is provided to introduce a selection of concepts, in a simplified format, that are further described in the detailed description. This summary is neither intended to identify key or essential concepts of the present disclosure nor is it intended for determining the scope of the present disclosure.

According to an aspect of the present disclosure, a system for recreating silicon behavior of a System on Chip (SoC) includes one or more traffic generators configured to generate traffic injectable into a Network on Chip (NoC) of the SoC based on silicon dump data, and a configurable memory controller configured to receive the silicon dump data associated with one or more masters of the SoC and the NoC, control one or more memory access latencies associated with the traffic based on one or more pre-configured master-corresponding latency values, and recreate the silicon behavior of the SoC by executing the traffic with the controlled one or more memory access latencies.

According to an aspect of the present disclosure, a method for recreating silicon behavior of a SoC includes receiving silicon dump data associated with one or more masters of the SoC and a NoC of the SoC, generating, using one or more traffic generators, traffic injectable into the NoC, based on the silicon dump data, controlling one or more memory access latencies associated with the traffic, based on one or more pre-configured master-corresponding latency values, and recreating the silicon behavior of the SoC by executing the traffic with the controlled one or more memory access latencies.

According to an aspect of the present disclosure, a device for recreating silicon behavior of a SoC includes one or more traffic generators configured to generate traffic injectable into a NoC of the SoC based on silicon dump data, one or more processors including processing circuitry, and a memory storing instructions. The instructions, when executed by the one or more processors individually or collectively, cause the device to receive the silicon dump data associated with one or more masters of the SoC and the NoC, control one or more memory access latencies associated with the traffic based on one or more pre-configured master-corresponding latency values, and recreate the silicon behavior of the SoC by executing the traffic with the controlled one or more memory access latencies.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 illustrates a network architecture of a system for recreating silicon behavior of a System on Chip (SoC), according to an embodiment of the present disclosure;

FIG. 2 illustrates a block diagram of the system for recreating silicon behavior, according to an embodiment of the present disclosure;

FIG. 3A illustrates a block diagram of a microcontroller of the system, according to an embodiment of the present disclosure;

FIG. 3B illustrates an example network architecture of the microcontroller, according to an embodiment of the present disclosure;

FIG. 4A illustrates an example network architecture of a configurable memory controller of the system, according to an embodiment of the present disclosure;

FIG. 4B illustrates an example block diagram for implementation of the configurable memory controller in the system, according to an embodiment of the present disclosure;

FIG. 5 illustrates an example block diagram for implementation of one or more traffic generators in the system, according an embodiment of the present disclosure;

FIG. 6 illustrates an example block diagram for implementation of one or more external modules in the system, according to an embodiment of the present disclosure; and

FIG. 7 illustrates a flowchart for a method for recreating silicon behavior of the SoC, according to an embodiment of the present disclosure.

### DETAILED DESCRIPTION

For the purpose of promoting an understanding of the present disclosure, reference is made to the various embodiments, and specific language is used to describe the same. It is to be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It is to be understood by those skilled in the art that the foregoing general description and the following detailed description are explanatory of the present disclosure and are not intended to be restrictive thereof.

To further clarify the advantages and features of the present disclosure, a more particular description is rendered by reference to specific embodiments thereof, which are illustrated in the appended drawings. It is appreciated that these drawings depict only typical embodiments of the present disclosure and are therefore not to be considered limiting to its scope. The present disclosure is described and explained with additional specificity in reference to the accompanying drawings.

Further, skilled artisans are to appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that are to be readily apparent to those of ordinary skill in the art having the benefit of the description herein.

Reference throughout the present disclosure to “an aspect,” “another aspect” or similar language means that a particular feature, structure, or characteristic described in connection with the embodiment is included in at least one embodiment of the present disclosure. Thus, appearances of the phrase “in an embodiment,” “in another embodiment” and similar language throughout the present disclosure may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises... a” does not, without more constraints, preclude the existence of other devices or other sub-systems or other elements or other structures or other components or additional devices or additional sub-systems or additional elements or additional structures or additional components.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as, but not limited to, device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

A System on Chip (SoC) may integrate multiple processing elements, memory controllers, interconnect fabrics, or the like onto a single semiconductor die. The SoC may include one or more masters that may perform various computational tasks. The interconnect fabrics may comprise Network on Chip (NoC) structures that may facilitate communication between the one or more masters and the memory controllers.

During development and deployment of SoC devices, performance-related issues may be encountered, which may manifest in the manufactured silicon. For example, the performance-related issues may include, but not be limited to, camera overflow conditions, display glitch conditions, multimedia processing anomalies, or the like. Camera overflow conditions may occur when image sensor data exceeds a buffer capacity. The display glitch conditions may occur when visual artifacts appear due to timing constraints and/or bandwidth constraints.

Debugging the performance-related issues in actual silicon may present various challenges. For example, direct observation of internal chip states and transaction patterns in actual silicon may be limited. As another example, iterative testing on physical hardware may be time-consuming and/or resource-intensive. As another example, access to internal states of the manufactured silicon for debugging purposes may be constrained.

Aspects of the present disclosure provide a system and a method for recreating silicon behavior of the SoC. The system may operate on a simulation platform, an emulation platform, or the like. The system may reproduce silicon issues pertaining to performance with relative accuracy and runtime efficiency. By recreating conditions that may lead to a performance-related issue, the system may provide for identification of the root cause of silicon issues. Alternatively or additionally, the system may provide for evaluation of software fixes for the silicon issues. The system may also provide for validation of the software fixes before confirming a software patch.

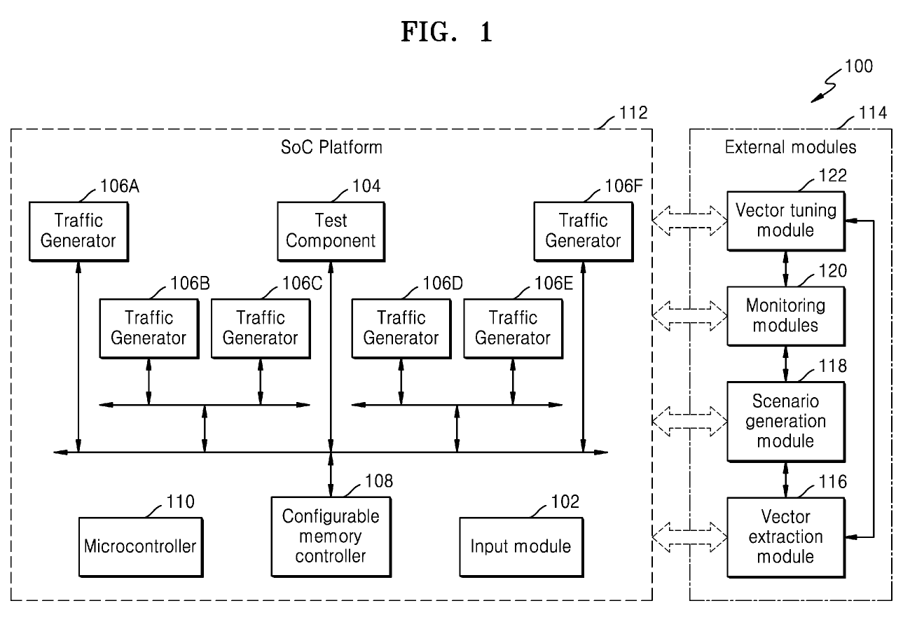

FIG. 1 illustrates a network architecture of a system 100 for recreating silicon behavior of a SoC, according to an embodiment of the present disclosure.

In an embodiment, the system 100 may be implemented as a platform (e.g., alternatively referred to as a SoC platform 112). The SoC platform 112 may be and/or may include a simulation platform, an emulation platform, or the like. The SoC platform 112 may provide a controlled environment for recreating silicon behavior observed in manufactured silicon. The SoC platform 112 may provide for testing and validation of the SoC without requiring physical silicon hardware.

In an embodiment, a test component 104 may be connected to the system 100 over the SoC platform 112. The test component 104 may represent a functional component of the SoC that may be under validation or debugging. The test component 104 may include, but not be limited to, a multimedia processing component, a camera processing component, a display processing component, an audio processing component, a video processing component, or any combination thereof. The test component 104 may include internal processing logic, buffer structures, and interface circuits. The test component 104 may communicate with other components through a NoC.

For example, the test component 104 may be and/or may include a camera subsystem within the SoC. In such an example, the camera subsystem may generate overflow conditions during high-resolution image capture. The overflow conditions may occur when a camera sensor generates data at a rate that may exceed available memory bandwidth. The overflow conditions may also occur when latency variations in a memory subsystem may cause buffer underruns. In an embodiment, the camera subsystem may include an image signal processor (ISP) that may process raw image data from the camera sensor. The ISP may need specific bandwidth and/or latency characteristics to maintain proper operation. When actual silicon exhibits camera overflow issues, the system 100 may recreate the conditions that may lead to the overflow to provide for root cause analysis.

The SoC platform 112 may further include architectural components that may be typically included in SoC designs. For example, the SoC platform 112 may include the NoC. The NoC may include an interconnect fabric that may facilitate communication between processing elements and/or memory controllers within the SoC. For example, the NoC may include data paths, routing logic, and arbitration mechanisms. The NoC may process transactions between one or more masters and/or one or more slaves within the SoC. The one or more masters may include processing elements that may initiate memory transactions. The one or more slaves may include memory controllers and/or peripheral devices that may respond to memory transactions.

The NoC may support multiple concurrent transactions from different masters. In an embodiment, the NoC may implement quality of service (QoS) mechanisms to prioritize certain transactions. The NoC may include buffering structures at various points in the interconnect fabric. The buffering structures may temporarily store transaction data during routing. The NoC may operate at specific clock frequencies that may vary during operation through dynamic frequency scaling (DFS).

In an embodiment, the system 100 may include one or more components or modules. Some components or modules may be connected internally to the SoC platform 112. Some components or modules may be connected externally to the SoC platform 112, such as, but not limited to, external modules 114. The one or more components or modules may include electronic hardware components, software modules, or a combination thereof. The electronic hardware components may include processors, microcontrollers, memory devices, and/or specially configured electronic circuits. The software modules may comprise executable instructions stored in non-transitory computer-readable storage media and executable by one or more processors. The one or more components or modules may be general purpose components such as, but not limited to, processors, microcontrollers, and/or may be configured to perform specific functions related to recreating silicon behavior of the SoC.

For example, each of the external modules 114 may be physically implemented by analog and/or digital circuits including one or more of a logic gate, an integrated circuit, a microprocessor, a microcontroller, a memory circuit, a passive electronic component, an active electronic component, an optical component, and the like. As another example, a field programmable gate array (FPGA) may be used to implement custom logic that may include the functionality of the external modules 114. As another example, a processor in combination with a memory may be used to execute one or more instructions to perform the functionality of the external modules 114. Alternatively or additionally, at least a portion of the functionality of external modules 114 may be incorporated into the SoC platform 112 and/or implemented as instructions to be executed by the SoC platform 112.

In an embodiment, the system 100 may include an input module 102. The input module 102 may be connected to the SoC platform 112. The input module 102 may be configured to receive silicon dump data. The silicon dump data may be associated with the one or more masters of the SoC and the NoC of the SoC. The silicon dump data may be captured from actual manufactured silicon during operation. The silicon dump data may contain information about transactions, timing, and internal states that occurred in the actual silicon when a performance issue was observed.

The silicon dump data may include bus configuration monitor (BCM) dump data. The BCM dump data may include transaction logs. The transaction logs may record bus transactions performed by the one or more masters during operation of the actual silicon. The transaction logs may include information about memory read transactions and memory write transactions. The transaction logs may include, but not be limited to, timestamps, master identifiers, transaction addresses, and transaction sizes.

The silicon dump data may further include silicon-to-debug (S2D) dump data. The S2D dump data may include internal state information. The internal state information may represent states of internal registers, buffers, and control signals within the actual silicon at specific moments in time. The S2D dump data may provide visibility into chip-internal conditions that may not be observable through external interfaces.

Referring to the previous example, when the camera subsystem generates an overflow condition in actual silicon, BCM dump data and/or S2D dump data may be captured. The BCM dump data may indicate the bandwidth and/or latency characteristics of transactions from the camera ISP master during the overflow. The S2D dump data may indicate buffer fill levels and/or state machine conditions within the camera subsystem at the time of overflow. The input module 102 may receive the BCM dump data and the S2D dump data for processing by other components of the system 100.

In an embodiment, the system 100 may include a vector extraction module (or vector extractor) 116. The vector extraction module 116 may be communicatively coupled to the input module 102. The vector extraction module 116 may be operable (configured) to extract information from the silicon dump data. The vector extraction module 116 may extract vector information comprising at least one of bandwidth information, latency information, or frequency scaling information on a per-master basis from the silicon dump data.

The bandwidth information may represent data transfer rates for each master over granular time intervals. The bandwidth information may include separate read bandwidth values and write bandwidth values for each master. The latency information may represent delays generated by each master during memory access operations over granular time intervals. The latency information may include average latency values and peak latency values. The latency information may include separate latency values for read transactions and write transactions. The frequency scaling information may represent changes in operating frequencies of the one or more masters and the NoC over time. The frequency scaling information may correspond to DFS events that may occur during operation.

The vector extraction module 116 may analyze the BCM dump data to extract the bandwidth information. The vector extraction module 116 may analyze timestamps and/or transaction sizes in the transaction logs to determine bandwidth utilization for each master. The vector extraction module 116 may analyze the BCM dump data and the S2D dump data to extract the latency information. The vector extraction module 116 may determine latency values based on transaction timing information and internal state information. The vector extraction module 116 may analyze the silicon dump data to identify frequency scaling events and/or extract the frequency scaling information.

The vector extraction module 116 may provide the extracted bandwidth information, latency information, and frequency scaling information to other components of the system 100. For example, the vector extraction module 116 may provide the extracted information to an architecture-aware test scenario generation module (or test scenario generator) 118 (indicated as scenario generation module 118) and to one or more traffic generators (e.g., a first traffic generator 106A, a second traffic generator 106B, a third traffic generator 106C, a fourth traffic generator 106D, a fifth traffic generator 106E, and a traffic generator 106F, hereinafter generally referred to as “106”).

Referring to the camera overflow example, the vector extraction module 116 may extract bandwidth information showing that the camera ISP master was transferring data at 500 megabits per second (Mbps) during the overflow event. The vector extraction module 116 may extract latency information showing that the camera ISP master generated peak read latencies of 150 nanoseconds (ns). The vector extraction module 116 may extract frequency scaling information showing that the NoC frequency was scaled down from approximately 800 megahertz (MHz) to approximately 600 MHz shortly before the overflow occurred.

In an embodiment, the system 100 may include the architecture-aware test scenario generation module 118. The architecture-aware test scenario generation module 118 may be communicatively coupled to the input module 102 and to the vector extraction module 116. The architecture-aware test scenario generation module 118 may be configured to derive configuration data from the silicon dump data. The configuration data may include architectural constraints of the SoC.

The architectural constraints may represent limitations and/or requirements imposed by the physical architecture of the SoC. The architectural constraints may include, but not be limited to, maximum bandwidth capacities of the NoC, buffer depth limitations, master-to-slave routing constraints, timing requirements, or the like. The architectural constraints may be embedded into algorithms executed by the architecture-aware test scenario generation module 118. The architecture-aware test scenario generation module 118 may generate test scenarios based on the architectural constraints.

The architecture-aware test scenario generation module 118 may be configured to generate one or more test scenarios. The one or more test scenarios may indicate master activity patterns and/or NoC loading conditions. The master activity patterns may specify which masters may be active during specific time intervals and what types of transactions the masters may perform. The NoC loading conditions may specify the traffic load on various portions of the NoC during operation. The one or more test scenarios may be based on the architectural constraints of the SoC.

The architecture-aware test scenario generation module 118 may be operable to generate test vectors. The test vectors may be based on the extracted bandwidth information, latency information, and frequency scaling information received from the vector extraction module 116. The test vectors may include structured data that specifies transaction parameters for traffic generation. For example, the test vectors may include, but not be limited to, timing information, transaction sizes, and sequencing requirements.

In the camera overflow example, the architecture-aware test scenario generation module 118 may derive architectural constraints indicating that the camera ISP master connects to a specific NoC path with a maximum bandwidth of 600 Mbps. The architecture-aware test scenario generation module 118 may generate test scenarios showing the camera ISP master active concurrently with other masters such as, but not limited to, display masters, audio masters, or the like. The test scenarios may reflect the NoC loading conditions that were present when the overflow occurred in actual silicon. The architecture-aware test scenario generation module 118 may generate test vectors specifying that the traffic generators 106 may produce 500 Mbps of read traffic from the camera ISP master while also producing traffic from the other masters.

In an embodiment, the system 100 may include one or more traffic generators 106. The one or more traffic generators 106 may be communicatively coupled to the input module 102. Each traffic generator 106 may correspond to a specific master in the SoC that is not under test and/or debug.

The one or more traffic generators 106 may be configured to generate traffic injectable into the NoC. The traffic may be based on the silicon dump data, information received from the vector extraction module 116, and/or the test vectors received from the architecture-aware test scenario generation module 118. The traffic may include memory read transactions and memory write transactions. For example, the traffic may replicate transaction patterns that occurred in actual silicon.

The one or more traffic generators 106 may be adaptive to system responses while achieving silicon bandwidth signatures. The silicon bandwidth signatures may represent the bandwidth characteristics observed in actual silicon. The one or more traffic generators 106 may dynamically adjust transaction timing to match the bandwidth targets extracted from the silicon dump data. The one or more traffic generators 106 may respond to backpressure and/or flow control signals from the NoC and adjust traffic generation accordingly, while maintaining overall bandwidth targets over granular time intervals.

In the camera overflow example, the first traffic generator 106A may represent the camera ISP master. The first traffic generator 106A may generate read transactions at 500 Mbps to match the bandwidth observed in actual silicon. As another example, the second traffic generator 106B may represent a display master that was also active during the overflow event. The second traffic generator 106B may generate write transactions to simulate display buffer updates. The one or more traffic generators 106 may collectively recreate the NoC loading conditions that was present when the camera overflow occurred.

In an embodiment, the system 100 may include a configurable memory controller 108. The configurable memory controller 108 may be connected to the SoC platform 112. The configurable memory controller 108 may be and/or may include a general-purpose memory controller with configurable latency characteristics. The configurable memory controller 108 may replace and/or model an actual memory controller that may be present in the manufactured silicon. The configurable memory controller 108 may receive memory transactions from the NoC. The configurable memory controller 108 may process the memory transactions and return responses with controlled timing.

The configurable memory controller 108 may be operable to control one or more memory access latencies associated with the traffic. The one or more memory access latencies may represent delays between a master initiating a memory transaction and the master receiving a response. The configurable memory controller 108 may control the one or more memory access latencies based on one or more pre-configured master-corresponding latency values.

The one or more pre-configured master-corresponding latency values may include a set of latency values configured for each master. Each master may have different latency values. The one or more pre-configured master-corresponding latency values may be programmed into the configurable memory controller 108 before execution of the traffic. The one or more pre-configured master-corresponding latency values may be derived from the latency information extracted by the vector extraction module 116.

The configurable memory controller 108 may be operable to control the one or more memory access latencies independently for read transactions and write transactions. The configurable memory controller 108 may apply different latency values to read transactions than to write transactions from the same master. The configurable memory controller 108 may identify the master that initiated each transaction based on a master identifier associated with the transaction. The configurable memory controller 108 may apply the corresponding latency value for the identified master.

The configurable memory controller 108 may be adaptive to system responses while achieving silicon latency signatures. The silicon latency signatures may represent the latency characteristics observed in actual silicon. The configurable memory controller 108 may maintain average latency values and/or peak latency values that may match the latency information extracted from the silicon dump data.

In the camera overflow example, the configurable memory controller 108 may be programmed with a pre-configured latency value of 150 nanoseconds for peak read latency for the camera ISP master. The configurable memory controller 108 may be programmed with different latency values for other masters such as, but not limited to, the display master. When the first traffic generator 106A generates read transactions representing the camera ISP master, the configurable memory controller 108 may introduce a delay of up to 150 ns before responding to the read transactions. The controlled latency may recreate the memory timing conditions that may have contributed to the camera overflow in actual silicon.

In an embodiment, the traffic, upon execution with the controlled one or more memory access latencies, may recreate the silicon behavior. The traffic generated by the one or more traffic generators 106 may flow through the NoC. The configurable memory controller 108 may process the traffic with latency characteristics matching actual silicon. The test component 104 may receive data from the one or more traffic generators 106 and may encounter timing and/or bandwidth conditions similar to those that occurred in actual silicon. The combination of accurate traffic generation and accurate latency control may cause the test component 104 to exhibit substantially similar and/or the same performance issues that were observed in manufactured silicon.

In the camera overflow example, when the first traffic generator 106A generates camera ISP traffic at 500 Mbps and the configurable memory controller 108 applies 150 ns read latencies while the NoC frequency is scaled to 600 MHz, the camera subsystem test component 104 may generate buffer overflow conditions matching those observed in actual silicon. The recreated silicon behavior may provide for the observation of the overflow condition in the simulation environment.

In an embodiment, the system 100 may include a microcontroller 110. The microcontroller 110 may be connected to the SoC platform 112. The microcontroller 110 may be and/or may include a processing element with control logic. The microcontroller 110 may serve as a central control engine for coordinating operation of various components of the system 100.

The microcontroller 110 may be operable to coordinate operation of the one or more traffic generators 106 and the configurable memory controller 108. The microcontroller 110 may send control signals to the one or more traffic generators 106 to initiate and/or stop traffic generation. The microcontroller 110 may synchronize the start of traffic generation across multiple traffic generators 106. The microcontroller 110 may send control signals to the configurable memory controller 108 to configure operational parameters.

The microcontroller 110 may be operable to manage configuration of the one or more pre-configured master-corresponding latency values. The microcontroller 110 may program the latency values into the configurable memory controller 108. The microcontroller 110 may update the latency values during iterative refinement of the simulation.

The microcontroller 110 may be operable to process system interrupts generated during execution of the traffic. The system interrupts may be generated by the test component 104 or other components when specific events occur. The system interrupts may indicate error conditions, completion of operations, or other events requiring attention. The microcontroller 110 may respond to the system interrupts and may take appropriate actions such as, but not limited to, logging the interrupts, adjusting system configuration, or the like.

The microcontroller 110 may be operable to adjust operating frequencies of the one or more traffic generators 106 and the configurable memory controller 108. The microcontroller 110 may implement DFS functionality. The microcontroller 110 may change the operating frequencies based on the frequency scaling information extracted from the silicon dump data. The microcontroller 110 may adjust operating frequencies across masters and the NoC to match frequency conditions that were present in the actual silicon.

The microcontroller 110 may be operable to handle configuration of system components and core intellectual property (IP) blocks. The microcontroller 110 may configure registers and control parameters of various components. The microcontroller 110 may provide performance statistics for tuning purposes. The performance statistics may include information about bandwidth utilization, latency distributions, and/or other operational metrics.

In the camera overflow example, the microcontroller 110 may coordinate the start of traffic generation by the first traffic generator 106A and other traffic generators 106. The microcontroller 110 may program the configurable memory controller 108 with the 150 ns latency value for the camera ISP master. The microcontroller 110 may adjust the NoC frequency from 800 MHz to 600 MHz at the appropriate time to match the frequency scaling that occurred in actual silicon. When the camera overflow occurs, the test component 104 may generate an interrupt, and the microcontroller 110 may handle the interrupt and log the overflow event.

In an embodiment, the system 100 may include at least one monitoring module (or performance monitor) 120. The at least one monitoring module 120 may be communicatively coupled to the SoC platform 112. The at least one monitoring module 120 may be configured to monitor one or more performance parameters of the SoC during execution of the traffic.

The one or more performance parameters may include, but not be limited to, bandwidth utilization metrics, latency measurements, buffer occupancy levels, transaction completion rates, error counts, and/or other observable characteristics of system operation. The one or more performance parameters may be measured during simulation execution when the traffic generated by the one or more traffic generators 106 is flowing through the NoC and being processed by the configurable memory controller 108.

The at least one monitoring module 120 may be configured to correlate the one or more performance parameters with corresponding reference parameter values. The corresponding reference parameter values may be derived from the silicon dump data. The corresponding reference parameter values may represent the performance parameters that were observed in actual silicon when the performance issue occurred. The correlation may include comparing the measured performance parameters from simulation with the reference parameter values from actual silicon.

The at least one monitoring module 120 may be configured to identify one or more silicon design issues based on the correlation. When the one or more performance parameters match the corresponding reference parameter values, the at least one monitoring module 120 may confirm that the silicon behavior has been accurately recreated. The at least one monitoring module 120 may identify specific conditions that lead to performance issues. The at least one monitoring module 120 may classify the silicon design issues as at least one of architectural issues, timing issues, or other categories of design issues.

In the camera overflow example, the at least one monitoring module 120 may monitor buffer fill levels in the camera subsystem test component 104 during execution of the traffic. The at least one monitoring module 120 may observe that the buffer fill level reaches 95% occupancy, matching the buffer occupancy observed in actual silicon from the S2D dump data. The at least one monitoring module 120 may correlate the simulated buffer occupancy with the reference buffer occupancy value of 95% from the silicon dump data. The at least one monitoring module 120 may identify the silicon design issue as insufficient buffer depth in the camera subsystem combined with inadequate bandwidth allocation during concurrent operation of multiple masters.

In an embodiment, the system 100 may include a vector tuning module (or vector tuner) 122. The vector tuning module 122 may be communicatively coupled to the at least one monitoring module 120 and to the architecture-aware test scenario generation module 118. The vector tuning module 122 may be operable to iteratively correlate the one or more performance parameters of the SoC during execution of the traffic with the corresponding reference parameter values.

The iterative correlation may involve multiple simulation runs. In each simulation run, the vector tuning module 122 may receive performance parameters from the at least one monitoring module 120. The vector tuning module 122 may compare the performance parameters with the corresponding reference parameter values. The vector tuning module 122 may determine differences and/or deviations between the simulated performance and the actual silicon performance.

The vector tuning module 122 may be operable to refine one or more test vectors and the one or more pre-configured master-corresponding latency values based on the correlation. When differences are detected between simulation and actual silicon, the vector tuning module 122 may adjust the test vectors to modify traffic generation patterns. The vector tuning module 122 may adjust the one or more pre-configured master-corresponding latency values to modify latency characteristics. The refined test vectors may be provided to the architecture-aware test scenario generation module 118 and the one or more traffic generators 106. The refined latency values may be provided to the microcontroller 110 for programming into the configurable memory controller 108.

The refinement process may repeat iteratively until the one or more performance parameters in simulation closely match (e.g., are substantially similar to) the corresponding reference parameter values from actual silicon. The iterative refinement may improve the accuracy of silicon behavior recreation. Through iterative tuning, the system 100 may converge to a configuration that may reproduce the conditions observed in manufactured silicon.

In the camera overflow example, in a first simulation run, the buffer fill level may reach only 85% instead of the target 95%. The vector tuning module 122 may identify the difference. The vector tuning module 122 may refine the test vectors to increase the bandwidth of the second traffic generator 106B representing the display master, thereby increasing contention on the NoC. The vector tuning module 122 may refine the pre-configured latency value for the camera ISP master from 140 ns to 150 ns. In a second simulation run with the refined parameters, the buffer fill level may reach 94%, closer to the target. After several iterations, the simulation may accurately recreate the 95% buffer occupancy and overflow condition observed in actual silicon.

Accordingly, the system 100 may provide a comprehensive platform for recreating silicon behavior of the SoC. The system 100 may receive silicon dump data from manufactured silicon through the input module 102. The system 100 may extract bandwidth information, latency information, and frequency scaling information through the vector extraction module 116. The system 100 may generate architecture-aware test scenarios through the architecture-aware test scenario generation module 118. The system 100 may generate traffic matching actual silicon through the one or more traffic generators 106. The system 100 may control memory access latencies matching actual silicon through the configurable memory controller 108. The system 100 may coordinate operations through the microcontroller 110. The system 100 may monitor performance and/or identify design issues through the at least one monitoring module 120. The system 100 may iteratively refine simulation parameters through the vector tuning module 122. Through the coordinated operation of these components, the system 100 may relatively accurately recreate silicon behavior and provide for effective debugging and validation of SoC designs, when compared to related systems.

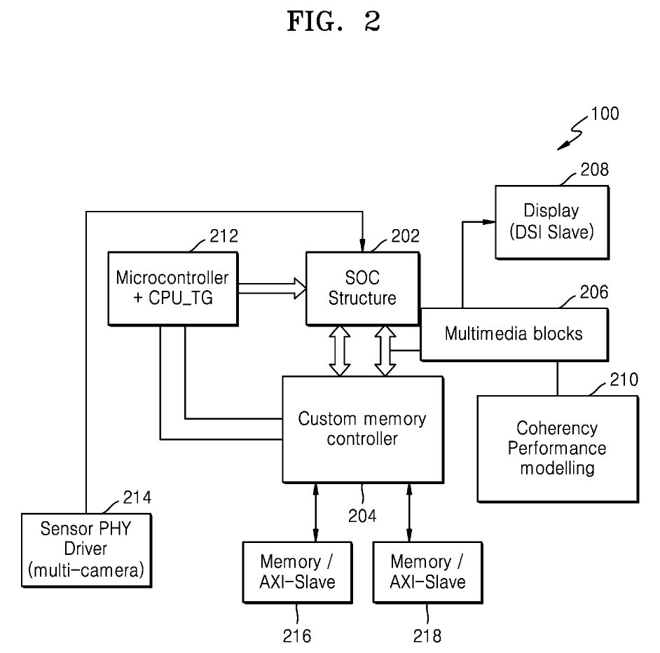

The implementation of the components or the one or more modules of the system 100 are further described in reference to FIGS. 2 to 6.

FIG. 2 illustrates an example block diagram of the system 100 for recreating silicon behavior, according to an embodiment of the present disclosure. Repeated descriptions of components and/or operations of the system 100 described above with reference to FIG. 1 may be omitted for the sake of brevity.

In an embodiment, a custom memory controller may be implemented at block 204. The custom memory controller may correspond to the configurable memory controller 108 of FIG. 1. The custom memory controller 204 may be and/or may include an identifier-based bus modeling engine. The custom memory controller 204 may control write latency and/or read latency including average latency values and/or peak latency values across a plurality of unique masters (e.g., 128 unique masters).

In an embodiment, a microcontroller with a central processing unit (CPU) traffic generator may be implemented at block 212. The microcontroller with CPU traffic generator may correspond to the microcontroller 110 of FIG. 1. The microcontroller 212 may function as a central control engine. The microcontroller 212 may control programming of configuration registers, process system interrupts, and/or process dynamic voltage and frequency scaling (DVFS) changes.

In an embodiment, a SoC structure may be implemented at block 202. The SoC structure 202 may represent the architectural organization of the SoC, including the NoC interconnect fabric, routing paths, buffering elements, and arbitration logic.

In an embodiment, multimedia blocks may be implemented at block 206. The multimedia blocks 206 may include, but not be limited to, functional components that may process multimedia data including ISP, data processing unit (DPU), video codec engines, audio processing units, or the like.

In an embodiment, a display interface may be implemented at block 208 as a display serial interface (DSI) slave. The DSI slave may replace actual physical display hardware and may capture and/or dump display output data to memory for analysis.

In an embodiment, a sensor physical layer (PHY) driver may be implemented at block 214 as a multi-camera sensor PHY driver. The sensor PHY driver 214 may replace actual physical camera sensor hardware and may feed image data to camera processing chains in the multimedia blocks 206.

In an embodiment, coherency performance modeling may be implemented at block 210. The coherency performance modeler 210 may be implemented using at least one of the monitoring modules 120 as described in reference to FIG. 1.

In an embodiment, memory interfaces may be implemented as advanced extensible interface (AXI) slaves at blocks 216 and 218. The first memory AXI slave 216 and the second memory AXI slave 218 may implement an AXI protocol and may model memory storage behavior.

The microcontroller with CPU traffic generator 212 may be communicatively coupled to the SoC structure 202 and the custom memory controller 204. The SoC structure 202 may be communicatively coupled to the multimedia blocks 206, the display (DSI slave) 208, the custom memory controller 204, and the coherency performance modeling 210. The custom memory controller 204 may be communicatively coupled to the first and second memory AXI slaves 216 and 218.

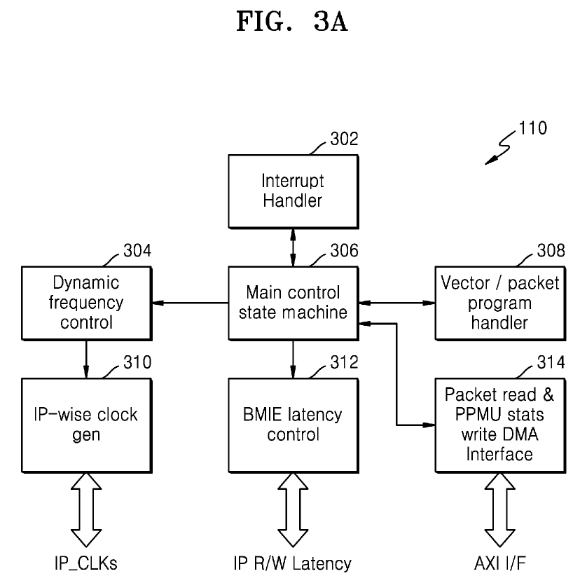

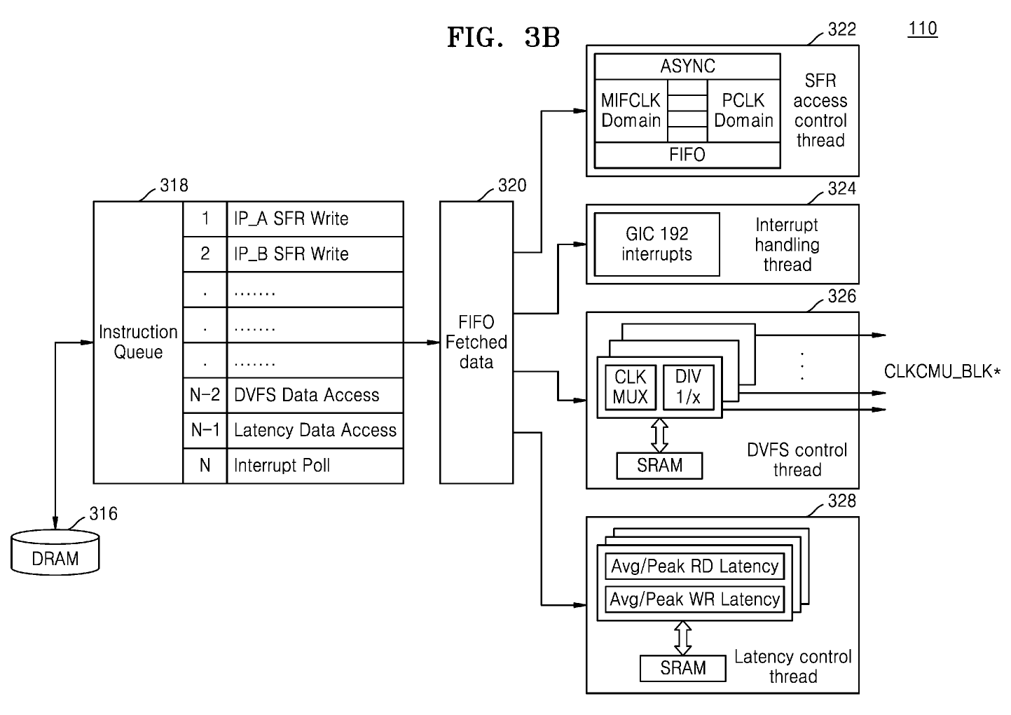

FIG. 3A illustrates an example block diagram of the microcontroller 110 of the system 100, according to an embodiment of the present disclosure. Repeated descriptions of the components and operations of the microcontroller 110 described with reference to FIGS. 1 and 2 may be omitted for the sake of brevity.

In an embodiment, an interrupt handler may be implemented at block 302. The interrupt handler 302 may receive system interrupts from various sources. The interrupt handler 302 may process the system interrupts and may trigger appropriate responses.

In an embodiment, a main control state machine may be implemented at block 306. The main control state machine 306 may coordinate overall operation of the microcontroller 110. The main control state machine 306 may manage sequencing of operations and may control transitions between operational states.

In an embodiment, a dynamic frequency control may be implemented at block 304. The dynamic frequency controller 304 may manage DVFS operations. The dynamic frequency controller 304 may adjust operating frequencies of system components based on frequency scaling information.

In an embodiment, a vector or packet program handler may be implemented at block 308. The vector or packet program handler 308 may process test vectors and program packets. The vector or packet program handler 308 may interpret test vector data and may configure system components accordingly.

In an embodiment, an IP-wise clock generator may be implemented at block 310. The IP-wise clock generator 308 may generate clock signals for individual IP blocks. The IP-wise clock generator 308 may provide independent clock signals that may be designated as IP_CLKs.

In an embodiment, a bus master interface engine (BMIE) latency control may be implemented at block 312. The BMIE latency controller 312 may control read latency and write latency for transactions. The BMIE latency controller 312 may manage IP read/write (R/W) latency values (IP R/W latency).

In an embodiment, a packet read and platform performance monitoring unit (PPMU) statistics write DMA interface may be implemented at block 314. The DMA interface 314 may read packet data and may write performance statistics collected by the PPMU. The DMA interface may use an AXI protocol interface (AXI I/F).

The interrupt handler 302 may be communicatively coupled to the main control state machine 306. The main control state machine 306 may be communicatively coupled to the dynamic frequency controller 304, the vector or packet program handler 308, and the BMIE latency controller 312. The dynamic frequency controller 304 may be communicatively coupled to the IP-wise clock generator 310. The vector or packet program handler 308 may be communicatively coupled to the packet read and PPMU stats write DMA interface 314.

FIG. 3B illustrates an example network architecture of the microcontroller 110, according to an embodiment of the present disclosure. Repeated descriptions of the components and operations of the microcontroller 110 described with reference to FIGS. 1, 2, and 3A may be omitted for the sake of brevity.

In an embodiment, an instruction queue may be implemented at block 318. The instruction queue 318 may store instructions for execution by the microcontroller 110. The instruction queue may include multiple entries. Each entry may correspond to a specific instruction type such as, but not limited to, IP_A Special Function Register (SFR) Write, IP_B SFR Write, DVFS Data Access, Latency Data Access, and Interrupt Poll. However, embodiments of the present disclosure are not limited thereto.

In an embodiment, first-in-first-out (FIFO) fetched data may be implemented at block 320. The FIFO 320 may temporarily store data fetched from the instruction queue 318. The FIFO 320 may provide buffering between the instruction queue 318 and the processing threads.

In an embodiment, a dynamic random access memory (DRAM) may be implemented at block 316. The DRAM 316 may store instruction data and/or configuration data. The instruction queue 318 may fetch instructions from the DRAM 316.

In an embodiment, an SFR access control thread may be implemented at block 322. The SFR access control thread 322 may process SFR access operations. The SFR access control thread 322 may include asynchronous clock domain crossing logic (ASYNC). The SFR access control thread 322 may include memory input register clock (MIRCLK) domain logic and peripheral clock (PCLK) domain logic. MIRCLK and PCLK may refer to different clock domains. The SFR access control thread 322 may include a FIFO logic for data synchronization.

In an embodiment, an interrupt handling thread may be implemented at block 324. The interrupt handling thread 324 may process interrupts from a generic interrupt controller (GIC). The GIC may support a plurality of interrupt sources (e.g., 192 or the like). The interrupt handling thread 324 may correspond to the interrupt handler 302 of FIG. 3A.

In an embodiment, a DVFS control thread may be implemented at block 326. The DVFS control thread 326 may implement the DVFS functionality. The DVFS control thread 326 may include a clock multiplexer (CLK MUX). The DVFS control thread 326 may include a clock divider (DIV 1/x). The clock divider may provide variable frequency division. The DVFS control thread 326 may include static random access memory (SRAM) for storing frequency configuration data. The DVFS control thread 326 may generate clock signals for multimedia blocks (CLKCMU_BLK*). The DVFS control thread 326 may correspond to the dynamic frequency control 304 of FIG. 3A.

In an embodiment, a latency control thread may be implemented at block 328. The latency control thread 328 may control latency values for memory transactions. The latency control thread 328 may manage average or peak read latency (e.g., avg/peak RD latency). The latency control thread may manage average or peak write latency (e.g., avg/peak WR latency). The latency control thread 328 may include an SRAM for storing latency configuration values. The latency control thread 328 may correspond to the BMIE latency control 312 of FIG. 3A.

The FIFO 320 may be communicatively coupled to the SFR access control thread 322, the interrupt handling thread 324, the DVFS control thread 326, and the latency control thread 328. Data from the FIFO 320 may be distributed to the appropriate thread based on instruction type.

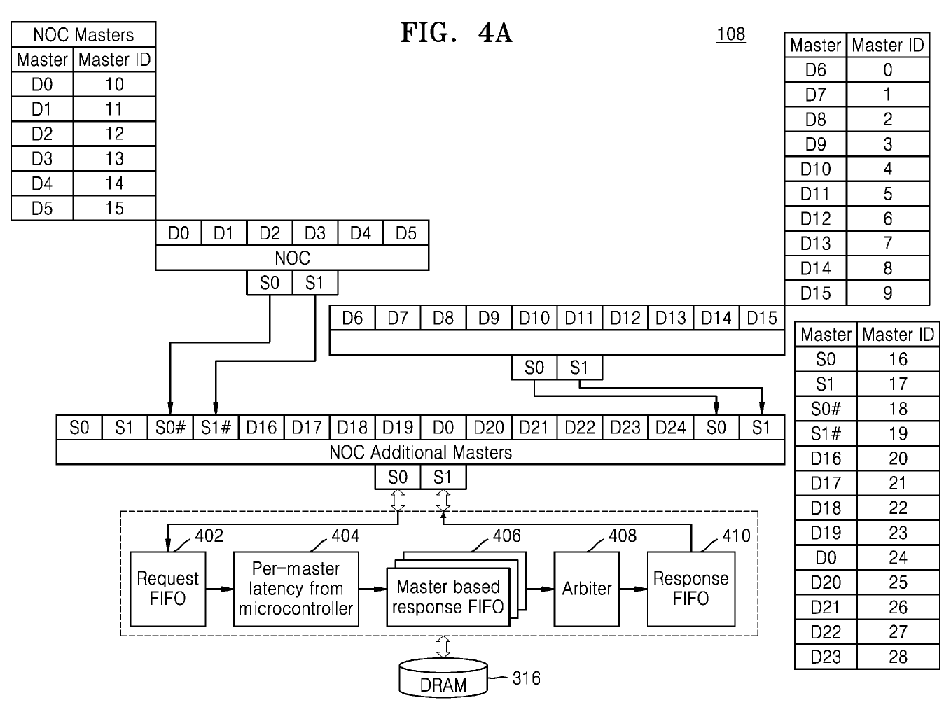

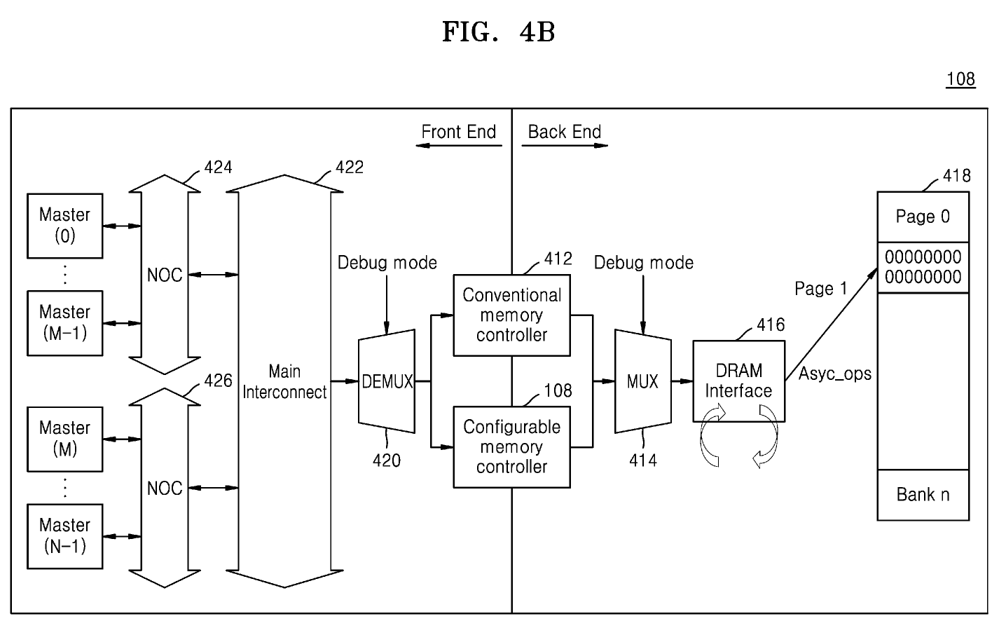

FIG. 4A illustrates an example network architecture of the configurable memory controller 108 of the system 100, according to an embodiment of the present disclosure. Repeated descriptions of the components and operations of the memory controller 108 described in with reference to FIGS. 1, 2, 3A, and 3B may be omitted for the sake of brevity.

In an embodiment, the configurable memory controller 108 may receive transactions from multiple masters through a hierarchical NoC structure. The NoC structure may include multiple NoC layers (e.g., NoC masters, NoC additional masters). The NoC masters may include masters with corresponding master identifiers. The NoC masters may connect to a first slave S0 and/or a second slave S1. Although FIG. 4A illustrates a particular configuration of masters and master identifiers, embodiments of the present disclosure are not limited in this regard. For example, various other quantities of masters and/or identifiers may be used without departing from the scope of the present disclosure.

In an embodiment, a request FIFO logic may be implemented at block 402. The request FIFO logic 402 may be configured to receive memory access requests from the one or more masters through the hierarchical NoC structure.

In an embodiment, per-master latency from microcontroller may be implemented at block 404. The per-master latency values 404 may be provided by the microcontroller 110. Each master may have corresponding latency values programmed into the configurable memory controller 108.

In an embodiment, a master based response FIFO may be implemented at block 406. The master based response FIFO 406 may store responses organized by master identifier. Each master may have a dedicated response queue within the master based response FIFO 406.

In an embodiment, an arbiter may be implemented at block 408. The arbiter 408 may select transactions for processing based on arbitration rules. The arbiter 408 may analyze and/or determine master priorities and transaction ages during arbitration.

In an embodiment, a response FIFO logic may be implemented at block 410 to control the one or more memory access latencies.

FIG. 4B illustrates a block diagram for implementation of the configurable memory controller 108 in the system 100, according to an embodiment of the present disclosure. Repeated descriptions of the components and operations of the memory controller 108 described in with reference to FIGS. 1, 2, 3A, 3B, and 4A may be omitted for the sake of brevity.

In an embodiment, the system 100 may be divided into a front end and a back end. The front end may include master interfaces and NoC structures. The back end may include memory controller components and memory interfaces. However, embodiments of the present disclosure are not limited thereto.

In an embodiment, multiple masters (e.g., a zero-th master Master (0), to an (M–1)-th master Master (M–1), an M-th master Master (M), to an (N–1)-th master Master (N–1), where N is a positive integer greater than one (1) and M is a positive integer greater than zero (0) and less than N) may be connected to the front end. The zero-th to (N–1)-th masters Master (0) to Master (N–1) may represent different masters in the SoC.

In an embodiment, the zero-th to (N–1)-th masters Master (0) to Master (N–1) may be connected at the front end through a main interconnect 422 via a first NoC 424 and a second NoC 426. The first and second NoCs 424 and 426 may provide parallel communication paths. The main interconnect 422 may route transactions between masters and memory controllers.

In an embodiment, a debug mode may be selected. The debug mode may allow selection between a conventional memory controller 412 and the configurable memory controller 108. A demultiplexer (DEMUX) may be implemented at block 420. The DEMUX 420 may route transactions to the conventional memory controller or the configurable memory controller based on debug mode settings. When the debug mode is selected, the traffic from the zero-th to (N–1)-th masters Master (0) to Master (N–1) may flow through the configurable memory controller 108 instead of the conventional memory controller 412.

In an embodiment, a conventional memory controller may be implemented at block 412. The conventional memory controller 412 may provide standard memory controller functionality without configurable latency features as those described in the present disclosure.

In an embodiment, the configurable memory controller 108 may operate in parallel with the conventional memory controller 412. A multiplexer (MUX) may be implemented at block 414. The MUX 414 may select outputs from the conventional memory controller 412 or the configurable memory controller 108 based on the debug mode.

In an embodiment, a DRAM interface may be implemented at block 416. The DRAM interface 416 may provide a physical interface to the DRAM memory 418. In an embodiment, the DRAM interface 416 may support asynchronous operations (Async_ops).

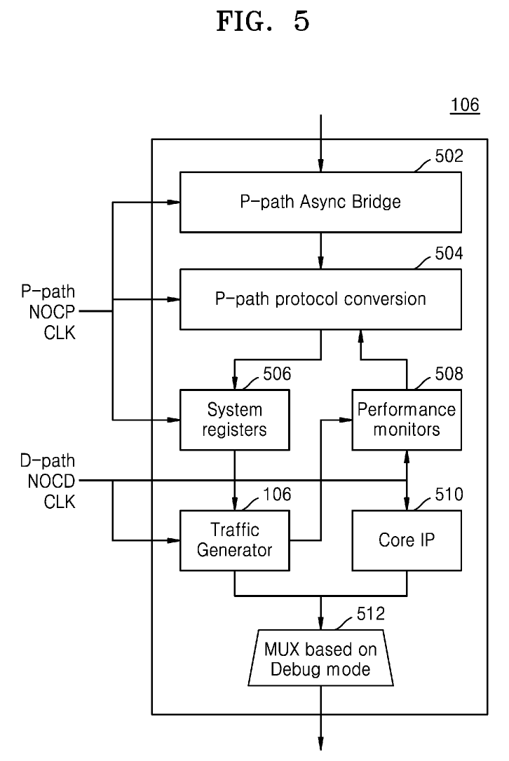

FIG. 5 illustrates an example block diagram for implementation of the one or more traffic generators 106 in the system 100, according to an embodiment of the present disclosure. Repeated descriptions of the components and operations of the traffic generators 106 described in with reference to FIGS. 1, 2, 3A, 3B, 4A, and 4B may be omitted for the sake of brevity.

In an embodiment, a P-path asynchronous bridge may be implemented at block 502. A P-path may refer to a programming path and/or a configuration path. The P-path asynchronous bridge 502 may perform clock domain crossing between different clock domains. The P-path may operate on P-path Network on Chip Programming clock (NOCP CLK).

In an embodiment, a P-path protocol conversion may be implemented at block 504. The P-path protocol converter 504 may convert protocol signals between different interface standards. The P-path protocol converter 504 may enable communication between configuration interfaces and internal traffic generator logic.

In an embodiment, system registers may be implemented at block 506. The system registers 506 may store configuration parameters for the traffic generator 106. The system registers 506 may include control registers and/or status registers.

In an embodiment, performance monitors may be implemented at block 508. The performance monitors 508 may monitor (or track) operational metrics of the traffic generator 106. The performance monitors 508 may measure bandwidth utilization and transaction counts.

In an embodiment, the traffic generator 106 may generate traffic based on test vectors and/or configuration data. The traffic generator 106 may operate on a Data path (D-path) Network on Chip Data clock (NOCD CLK). The traffic generator 106 may be communicatively coupled to the system registers 506 and the performance monitors 508.

In an embodiment, a core IP may be implemented at block 510. The core IP 510 may represent actual functional IP blocks that the traffic generator 106 may replace during simulation. The core IP 510 may include, but not be limited to, multimedia processing blocks or other processing elements.

In an embodiment, a multiplexer based on debug mode may be implemented at block 512. The multiplexer 512 may select between output from the traffic generator 106 and output from the core IP 510. The debug mode may determine whether the system 100 operates with traffic generators 106 or with actual core IP blocks 510.

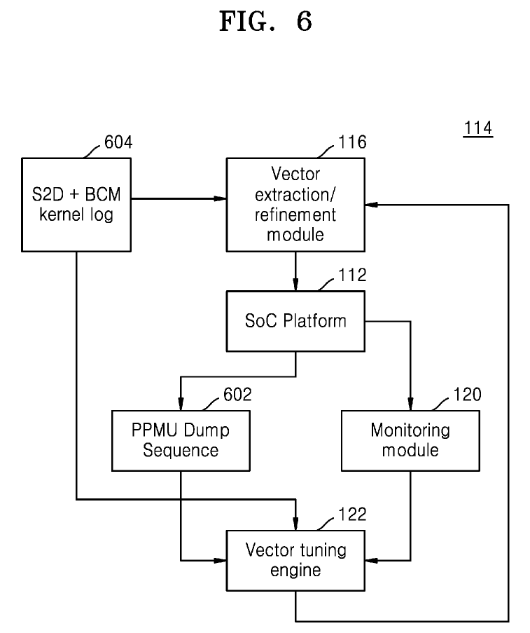

FIG. 6 illustrates an example block diagram for implementation of the one or more external modules 114 in the system 100, according to an embodiment of the present disclosure. Repeated descriptions of the components and operations of the external modules 114 described in with reference to FIGS. 1, 2, 3A, 3B, 4A, 4B, and 5 may be omitted for the sake of brevity

In an embodiment, S2D and BCM kernel log may be implemented at block 604. The S2D and BCM kernel log 604 may include silicon dump data including S2D dump data, BCM dump data, and kernel log data. The S2D and BCM kernel log 604 may provide input data captured from actual silicon.

In an embodiment, the vector extraction/refinement tool 116 may receive the silicon dump data from the S2D and BCM kernel log 604. The vector extraction/refinement tool 116 may extract bandwidth information, latency information, and frequency scaling information. The vector extraction/refinement tool 116 may refine test vectors based on feedback from the vector tuning module 122.

In an embodiment, the SoC platform 112 may receive extracted information and test vectors from the vector extraction/refinement tool 116. The SoC platform 112 may execute traffic with controlled latencies to recreate silicon behavior.

In an embodiment, a PPMU dump sequence may be implemented at block 602. The PPMU dump sequence 602 may include performance data collected during execution on the SoC platform 112. The PPMU dump sequence 602 may include performance counters and timing measurements.

In an embodiment, the monitoring module 120 may receive performance data from the SoC platform 112. The monitoring module 120 may monitor the one or more performance parameters during execution of the traffic. The monitoring module 120 may correlate the one or more performance parameters with corresponding reference parameter values.

In an embodiment, the vector tuning module 122 may receive correlated performance data from the monitoring module 120. The vector tuning module 122 may receive PPMU dump sequence data from block 602. The vector tuning module 122 may iteratively refine test vectors and latency values based on differences between simulated performance and actual silicon performance. The vector tuning module 122 may provide refined parameters back to the vector extraction/refinement tool 116.

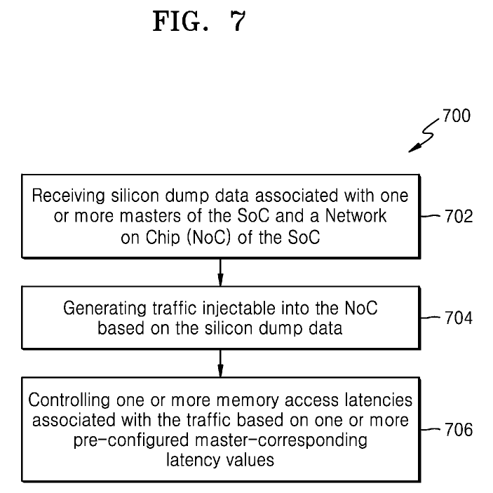

FIG. 7 illustrates a flowchart depicting a method 700 for recreating silicon behavior of the SoC, according to an embodiment of the present disclosure. The method 700 may be a computer-implemented method executed by the system 100 and the one or more components or modules described in reference to FIGS. 1, 2, 3A, 3B, 4A, 4B, 5, and 6. Repeated descriptions of constructional and operational features of the system 100 described with reference to FIGS. 1, 2, 3A, 3B, 4A, 4B, 5, and 6 may be omitted for the sake of brevity.

The method 700, at operation 702, may receive the silicon dump data associated with the one or more masters of the SoC and the NoC of the SoC. At operation 704, the method 700 may generate the traffic injectable into the NoC based on the silicon dump data. Subsequently, at operation 706, the method 700 may control the one or more memory access latencies associated with the traffic based on the one or more pre-configured master-corresponding latency values. The traffic upon execution with the controlled one or more memory access latencies may recreate the silicon behavior.

At least by virtue of the aforesaid, the present subject matter at least provides the following advantages.

The present disclosure herein provides a system for recreating silicon behavior of a SoC by utilizing actual silicon dump data captured from manufactured silicon, thereby enabling relatively accurate reproduction of performance-related issues in a simulation and/or emulation environment without requiring physical silicon hardware.

The system and the method of the present disclosure provided herein reduce the need for repeated silicon fabrication cycles by providing for the identification of root causes of possible silicon issues, evaluation of software fixes, and validation of the software fixes in a simulation environment, thereby significantly reducing development time and fabrication costs, when compared to related systems and methods.

The system and the method of the present disclosure provided herein implement a configurable memory controller configured to control one or more memory access latencies independently for each master, thereby relatively accurately recreating memory timing conditions that may contribute to possible silicon performance issues.

The system and the method of the present disclosure provide independent control of read transactions and write transactions for each master through the configurable memory controller, thereby providing for relatively precise recreation of latency characteristics observed in actual silicon for different transaction types.

The system and the method of the present disclosure provided herein implement one or more traffic generators configured to generate traffic injectable into the NoC, thereby recreating actual transaction patterns and bandwidth characteristics that may have occurred in manufactured silicon.

The system and the method of the present disclosure provided herein provide for architectural validation of future SoC designs by allowing evaluation of design decisions such as, but not limited to, changes to bus architectures, buffer depths, memory organization, or the like prior to silicon fabrication, thereby potentially reducing risk associated with architectural changes.

The system and the method of the present disclosure provided herein implement adaptive traffic generation that may respond to system behavior, thereby maintaining realistic traffic patterns that may account for dynamic system responses and/or backpressure conditions.

While specific language has been used to describe the present disclosure, any limitations arising on account of the same are not intended. As is to be apparent to a person skilled in the art, various working modifications may be made to the system and method provided herein in order to implement the present disclosure as taught herein. It is therefore intended that the appended claims encompass any such modifications or embodiments.

The drawings and the forgoing description give examples of embodiments. Those skilled in the art are to appreciate that one or more of the described elements may well be combined into a single functional element. Alternatively or additionally, certain elements may be split into multiple functional elements. Elements from one embodiment may be added to another embodiment. For example, orders of processes described herein may be changed and are not limited to the manner described herein.

What is claimed is:

1. A system for recreating silicon behavior of a System on Chip (SoC), the system comprising:
one or more traffic generators configured to generate traffic injectable into a Network on Chip (NoC) of the SoC based on silicon dump data; and
a configurable memory controller configured to:
receive the silicon dump data associated with one or more masters of the SoC and the NoC,
control one or more memory access latencies associated with the traffic based on one or more pre-configured master-corresponding latency values, and
recreate the silicon behavior of the SoC by executing the traffic with the controlled one or more memory access latencies.

2. The system of claim 1, further comprising at least one performance monitor configured to:
monitor one or more performance parameters of the SoC during execution of the traffic,
correlate the one or more performance parameters with corresponding reference parameter values, and
identify, based on the correlation, one or more silicon design issues.

3. The system of claim 1, further comprising a test scenario generator configured to:
derive configuration data from the silicon dump data, the configuration data comprising architectural constraints of the SoC, and
generate, based on the architectural constraints of the SoC, one or more test scenarios indicating a master activity pattern and NoC loading conditions.

4. The system of claim 3, further comprising a vector extractor configured to:
extract, from the silicon dump data, vector information comprising at least one of bandwidth information, latency information, or frequency scaling information on a per-master basis, and
provide, to the test scenario generator and the one or more traffic generators, the vector information.

5. The system of claim 4, wherein the test scenario generator is further configured to:
generate test vectors based on the vector information.

6. The system of claim 2, further comprising a vector tuner configured to:
iteratively correlate the one or more performance parameters of the SoC during execution of the traffic with the corresponding reference parameter values, and
refine, based on the correlation, one or more test vectors and the one or more pre-configured master-corresponding latency values.

7. The system of claim 1, wherein the configurable memory controller is further configured to:
control the one or more memory access latencies independently for read transactions and write transactions.

8. The system of claim 1, wherein the silicon dump data comprises:
bus configuration monitor (BCM) dump data comprising transaction logs; and
silicon-to-debug (S2D) dump data comprising internal state information.

9. The system of claim 1, further comprising a microcontroller configured to:
coordinate operation of the one or more traffic generators and the configurable memory controller,
manage configuration of the one or more pre-configured master-corresponding latency values,
process system interrupts generated during execution of the traffic, and
adjust operating frequencies of the one or more traffic generators and the configurable memory controller.

10. A method for recreating silicon behavior of a System on Chip (SoC), the method comprising:
receiving silicon dump data associated with one or more masters of the SoC and a Network on Chip (NoC) of the SoC;
generating, using one or more traffic generators, traffic injectable into the NoC, based on the silicon dump data;
controlling one or more memory access latencies associated with the traffic, based on one or more pre-configured master-corresponding latency values; and
recreating the silicon behavior of the SoC by executing the traffic with the controlled one or more memory access latencies.

11. The method of claim 10, further comprising:
monitoring one or more performance parameters of the SoC during execution of the traffic;
correlating the one or more performance parameters with corresponding reference parameter values; and
identifying, based on the correlating, one or more silicon design issues.

12. The method of claim 10, further comprising:
deriving configuration data from the silicon dump data, the configuration data comprising architectural constraints of the SoC; and
generating, based on the architectural constraints of the SoC, one or more test scenarios indicating a master activity pattern and NoC loading conditions.

13. The method of claim 12, further comprising:
extracting, from the silicon dump data, vector information comprising at least one of bandwidth information, latency information, or frequency scaling information on a per-master basis; and
providing, to the one or more traffic generators, the vector information.

14. The method of claim 13, further comprising:
generating test vectors based on the vector information.

15. The method of claim 11, further comprising:
iteratively correlating the one or more performance parameters of the SoC during execution of the traffic with the corresponding reference parameter values; and
refining, based on the correlating, one or more test vectors and the one or more pre-configured master-corresponding latency values.

16. The method of claim 10, further comprising:
controlling the one or more memory access latencies independently for read transactions and write transactions.

17. The method of claim 10, wherein the silicon dump data comprises:
bus configuration monitor (BCM) dump data comprising transaction logs; and
silicon-to-debug (S2D) dump data comprising internal state information.

18. The method of claim 10, further comprising:
coordinating operation of the one or more traffic generators;
managing configuration of the one or more pre-configured master-corresponding latency values;
processing system interrupts generated during execution of the traffic; and
adjusting operating frequencies of the one or more traffic generators.

19. A device for recreating silicon behavior of a System on Chip (SoC), the device comprising:
one or more traffic generators configured to generate traffic injectable into a Network on Chip (NoC) of the SoC based on silicon dump data;
one or more processors comprising processing circuitry; and
a memory storing instructions,
wherein the instructions, when executed by the one or more processors individually or collectively, cause the device to:
receive the silicon dump data associated with one or more masters of the SoC and the NoC;
control one or more memory access latencies associated with the traffic based on one or more pre-configured master-corresponding latency values; and
recreate the silicon behavior of the SoC by executing the traffic with the controlled one or more memory access latencies.

20. The device of claim 19, wherein the instructions, when executed by the one or more processors individually or collectively, further cause the device to:
coordinate operation of the one or more traffic generators;
manage configuration of the one or more pre-configured master-corresponding latency values;
process system interrupts generated during execution of the traffic; and
adjust operating frequencies of the one or more traffic generators.
